(19) United States
(12) Patent Application Publication
(10) Pub. No.: US 2002/0076060 A1
(43) Pub. Date: Jun. 20, 2002

(54) Programmable headset and programming apparatus and method

(76) Inventors: Ronald W. Hall, South St. Paul, MN (US); Daryl T. Burkhard, Erie, CO (US); Harry B. Taylor, Lafayette, CO (US)

Correspondence Address: MERCHANT & GOULD PC, P.O. BOX 2903, MINNEAPOLIS, MN, 55402-0903, US

(21) Appl. No.: 09/740,524

(22) Filed: Dec. 19, 2000

(51) Int. Cl. H04R 1/10; H04B 3/00; H04R 25/00

(52) U.S. Cl. 381/74; 381/77; 381/374; 381/384

(57) ABSTRACT

A programmable headset is provided including an infrared light detector for receiving infrared light signals to establish operational settings. An apparatus for programming a headset is also provided including a headset and a programming unit that includes an infrared light emitter for communication with the infrared light detector of the headset. The programming unit may also include a cradle for receiving a portion of the headset.

### FIELD OF THE INVENTION

The present invention is directed to communication devices and methods for programming communication devices, and more particularly to programmable headsets and a programming apparatus and method.

### BACKGROUND OF THE INVENTION

Headset assemblies are frequently used in a wide variety of applications and across a broad range of industries. For example, in the fast food industry, one or more employees at drive-through fast food restaurants typically wear a headset assembly to receive orders from patrons in the drive-through lane. Similarly, in the banking industry, tellers at banks having drive-through lanes may wear headset assemblies to communicate with customers. In the retail industry, headsets are commonly used by stockroom and other employees to communicate with one another within a large area, such as a department store or a warehouse.

A typical headset assembly includes a headband and an electronics housing. The electronics housing may be attached to one end of the headband and usually includes an earphone speaker, a microphone boom, and the electronic circuitry necessary to operate the earphone and microphone and transmit and receive audio signals.

The headset assembly may also include a programming interface for receiving operating parameters, such as transmission frequencies. The programming interface is typically a cable connector for receiving a cable connection. In prior art devices, the programming interface often includes metal prongs for connecting to a cable, similar to those used for telephone connections.

While being commonplace in many commercial settings, conventional headsets may fail due to rough physical handling and use in a less than pristine environment. The programming interface may fail due to grease, dust or dirt contamination, bent prongs, repeated dropping of the headset assembly or insertion of an object other than the cable.

### SUMMARY OF THE INVENTION

A programmable headset is described including a headband and an electronics housing where the electronics housing includes an infrared light detector arranged to receive infrared light signals, convert the infrared light signals into electric signals and supply the electric signals to an output. The headset infrared light detector is located in a detector portion of the electronics housing. The electronics housing also includes a headset signal processing device with an input coupled to the output of the headset infrared light detector. The electronics housing may also include a transmitter and a receiver that are operably connected to the headset signal processing device.

The headset may also include a battery attached to the headband and operably connected to the headset signal processing device. The headset may also include a programming unit that has a cradle for receiving the detector portion of the headset. The programming unit may also have a programming unit signal processing device with an output and a programming unit infrared light emitter positioned for infrared light communication with the headset when the detector portion is positioned in the cradle.

The headset and the programming unit may each be provided with infrared light emitter detector elements for allowing two-way infrared communication between the headset and the programming unit. The detector portion of the electronics housing may be located at an end of the electronics housing. Such positioning may facilitate placement of the detector portion of the headset in the cradle of the programming unit.

The electronics housing may be attached to the headband in the present invention. In the alternative, the electronics housing may be separate from the headband but may be operably coupled to the headband by a wire connection, where the headband includes a speaker and a microphone.

An apparatus for programming a headset is also described herein including a headset and a programming unit. The headset includes a headband, a headset signal processing device, a headset infrared light detector positioned in a detector portion, and a speaker. The programming unit includes a cradle for receiving the detector portion of the headset, a programming unit infrared light emitter and a programming unit signal processing device operably connected to the programming unit infrared light emitter.

The apparatus for programming a headset may also include a base unit connected to the programming unit, where the base unit includes a control panel. In the alternative, the programming unit may include a control panel.

Preferably, the programming unit of the present invention is configured and sized to be mounted on a wall. The detector portion of the headset may be located at an end portion of the headset. The detector portion may include a window of infrared light transparent material.

The programming unit may include a housing that at least partially encloses the programming unit infrared light emitter and the programming unit signal processing device, where the cradle is defined in the housing. In one embodiment, at least a portion of the cradle comprise an infrared light transparent material. The cradle may consist of an infrared light transparent material in its entirety. Further, the entire housing of the programming unit may be made of an infrared light transparent material.

A method of programming a headset is described including positioning a detector portion of a headset in a cradle of a programming station, where the headset includes a headset infrared light detector for receiving signals from a programming station infrared light emitter. The method may also include the steps of transmitting an infrared light signal from the programming station to the headset where the signal contains information regarding operation settings of the headset and establishing operation settings of the headset in response to the signal. The method may also includes the step of indicating a ready condition of the headset for receiving a programming signal by transmitting an infrared light signal from the headset to the programming station. The step of indicating a ready condition may include turning the headset power on.

### BRIEF DESCRIPTION OF THE DRAWINGS

The invention may be more completely understood by considering the detailed description of various embodiments of the invention which follows in connection with the accompanying drawings.

FIG. 1 is a perspective view from the front and side of a programmable headset of the present invention.

FIG. 2 is a side view of the programmable headset of FIG. 1.

FIG. 3 is a perspective view from the back and side of the programmable headset of FIG. 1.

FIG. 4 is a side view of the programmable headset of FIG. 1 positioned in a programming unit of the present invention.

FIG. 5 is a cross-sectional view of a portion of the headset assembly of FIG. 4 positioned in the programming unit taken along line 5-5 in FIG. 4.

FIG. 6 is a perspective view of a programming unit of the present invention.

FIG. 7 is a block diagram of the headset, programming station and base station of the present invention.

FIG. 8 is a perspective view of the base station of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents and alternatives falling within the spirit and scope of the invention as defined by the appended claims.

### DETAILED DESCRIPTION OF THE VARIOUS EMBODIMENTS

The present invention is believed to be applicable to a variety of systems and arrangements for communication in a commercial setting. The invention has been found to be particularly advantageous where headset assemblies are worn by users for remote communication. While the present invention is not so limited, an appreciation of various aspects of the invention is best gained through a discussion of various application examples operating in such an environment.

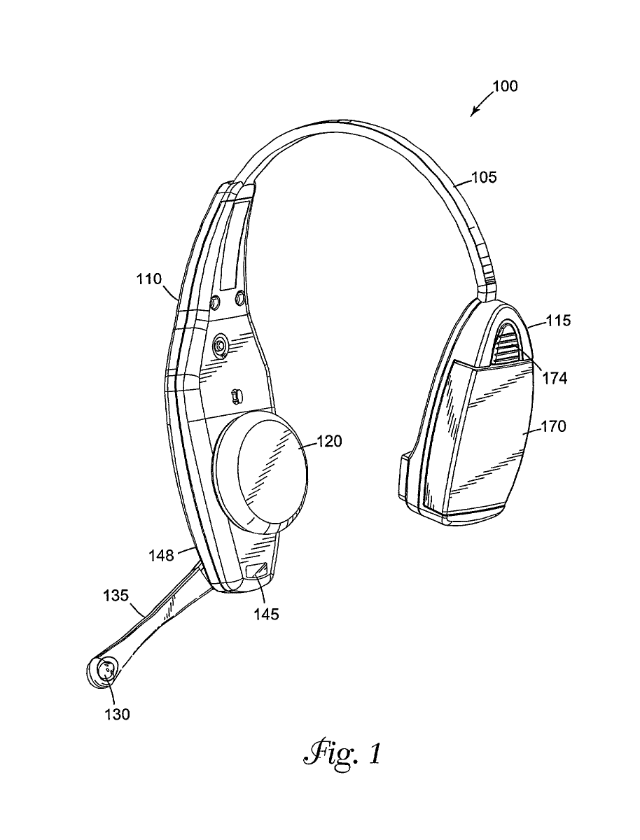

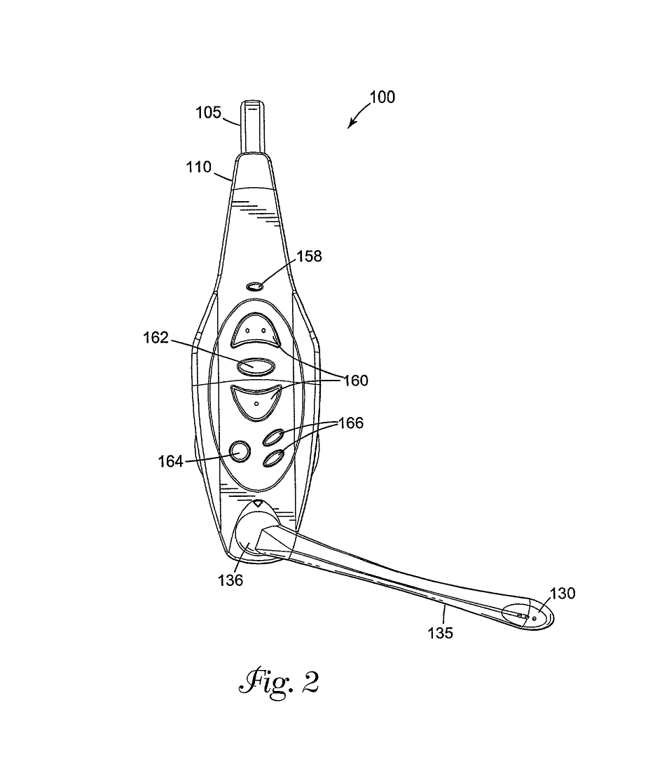

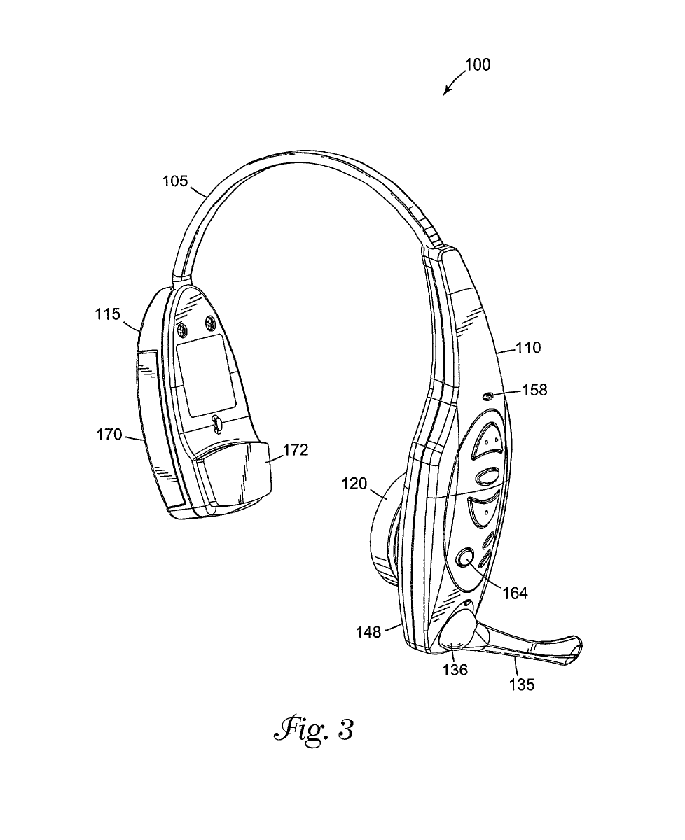

FIGS. 1-3 illustrate one particular embodiment of the invention in which a headset 100 includes a headband 105, an electronics housing 110 and a battery housing 115. An infrared (IR) light detector is provided within the electronics housing 110 behind an infrared window 145, and is therefore not visible in FIGS. 1-3. The infrared light detector is used to receive infrared signals for establishing settings of the headset device according to the present invention. Examples of settings that may be programmed include amplifier gain, transmission frequencies and reception frequencies.

In one embodiment, the headset may include an IR light emitter in addition to an IR light detector. In this embodiment, an IR light emitter detector element may be included in the headset. Infrared light transmission by the headset 100 is useful for indicating to a base station or a programming station that the headset 100 is ready to receive a programming signal, as will be discussed in more detail below. However, infrared detection capabilities may be provided to the headset 100 without providing infrared transmission capabilities.

The use of an infrared light detector to receive settings for headset operation provides an alternative to the cable connection for programming that is used in some programmable headset constructions. Headsets are frequently used in fast food restaurants or other settings where they are subjected to very rough handling and dirty or greasy conditions. As a result, cable connections may be unreliable in these settings. Grease can damage a cable connection. Repeated dropping of a headset on a concrete surface may cause the cable connection to shift in the electronics housing of the headset and therefore prevent proper alignment of the connectors. Insertion of items other than the cable connector into a connector port, such as a pencil, may damage the cable connection also.

In the embodiment of FIGS. 1-3, the infrared detector is located in a detector portion 148 of the electronics housing 110. In this embodiment, the detector portion is a bottom end portion of the electronics housing 110. The detector window 145 may be on the side of the housing 110 that will be nearest to the wearer during use. The location of the infrared light detector and therefore the detector portion 148 at an end of the electronics housing 110 provides convenience in programming because the infrared window 145 can be easily located. In addition, the detector portion 148 of the electronics housing may be easily inserted into a device for downloading the infrared program to the headset. An example of a programming device of the present invention for use with an IR light programmable headset will be discussed in greater detail herein.

Although the infrared light detector is located at a bottom end of the electronics housing 110 in the preferred and illustrated embodiment, it is also possible to position the infrared light detector at other places within the electronics housing 110 or on the headset. For example, the infrared light detector could be located at a top end of the electronics housing 110 or could be located near the middle of the electronics housing 110. The infrared light detector could be located either on the side of the electronics housing 110 that will be positioned next to the head of the wearer or on the opposite side. The selected position of the infrared light detector should allow for reception of IR light signals during programming.

It is also possible for the programmable headset of the present invention to have an electronics housing that is not attached to the headband. For example, the electronics housing could be connected to the headband by a cable. The electronics housing could instead be wearable by a user on a belt clip or attached to other clothing. The headband could include a speaker and/or microphone, while other components such as the infrared detector and/or battery may be in the electronics housing. This type of configuration allows for less weight to be attached to the headband. However, the two piece construction may be inconvenient for some reasons. Not all users wear belts and other clothing may not adequately support the electronics housing. The cable required could get caught on objects. The embodiment of the present invention where the electronics housing is attached to the headband will be discussed and illustrated hereinafter. However, it should be understood that the present invention encompasses a headset where the electronics housing is not attached to the headband.

In addition to the IR light detector and IR window 145, the headset 100 may also include many other operational components. An ear pad 120 may be attached to the electronics housing 110 for comfortably positioning the headset assembly against a user's ear. Behind the ear pad 120, a speaker may be included, not visible in FIGS. 1-3. The electronics housing 110 may also include a microphone 130 located on a microphone boom 135. The microphone boom 135 may be rotatable about its connection point 136 to the electronics housing 110 to facilitate the position of the ear pad 120 on the wearer's left or right ear, the microphone position preference of the user, or a non-use position. Alternatively, the headset may not include a microphone, or may include a microphone located in another place on the electronics housing or attached to the electronics housing or another part of the headset.

The electronics housing 110 may include a variety of control buttons and indicator lights as may be desirable for operation. For example, the electronics housing 110 may include an LED 158 for indicating use or other conditions. Lane buttons 160 may also be included to allow a user to switch between communication with different locations, for example, different lanes in a drive-through restaurant. The electronics housing 110 may also include a talk lock button 162, a page button 164 and/or volume buttons 166. The electronics housing 110 may include one or more of the above described control features and does not need to include all features. The electronics housing may include different further control, indicator and other features that are desirable for headset operation. The position and shape of the various input devices and indicators on the headset may be altered to provide user convenience and a preferred appearance.

The headband 105 may be adjustable to increase the size of the headset assembly or in other ways. At the end of the headband 105 opposite from the electronics housing 110, a battery housing 115 may be located. The battery housing may include a battery or battery pack 170 that slides into position in the battery housing 115. The battery housing 115 may also include a battery head pad 172 and a battery pack release button 174.

A programming station to transmit IR light programming signals to a programmable headset assembly of the present invention includes an infrared light emitter or transmitter for sending an infrared light signal to the programmable headset. Communication between an infrared light emitter of the programming station and an infrared light detector of the headset may take place at many different distance ranges, depending on the types of components that are used and the objectives of the system. For example, infrared communication at distances of a few inches is reliable and has low power requirements. Infrared communication over longer distances, for example, up to fifteen feet, can be more convenient for the users as it does not require positioning the two communication elements within very close range, but has higher power requirements. For many headset uses, the lower power requirements and reliability of infrared communication at relatively short distances are preferred. Therefore, IR communication is preferred at distances of less than 10 centimeters, more preferably distances of 5 cm or less, still more preferably distances of 2 cm or less. However, for some uses, IR communication over longer distances is preferred.

In one embodiment of the present invention, a programming station may provide a distinct physical reference for positioning the headset during programming. A structure of the programming station that assists with positioning the headset assembly is helpful for ensuring that users of the headset can quickly, easily and reliably download a program from the programming station to the headset.

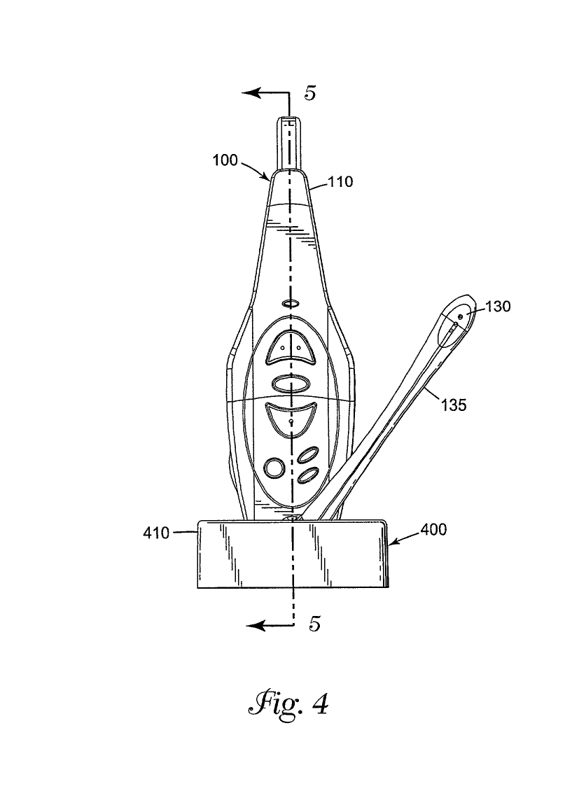

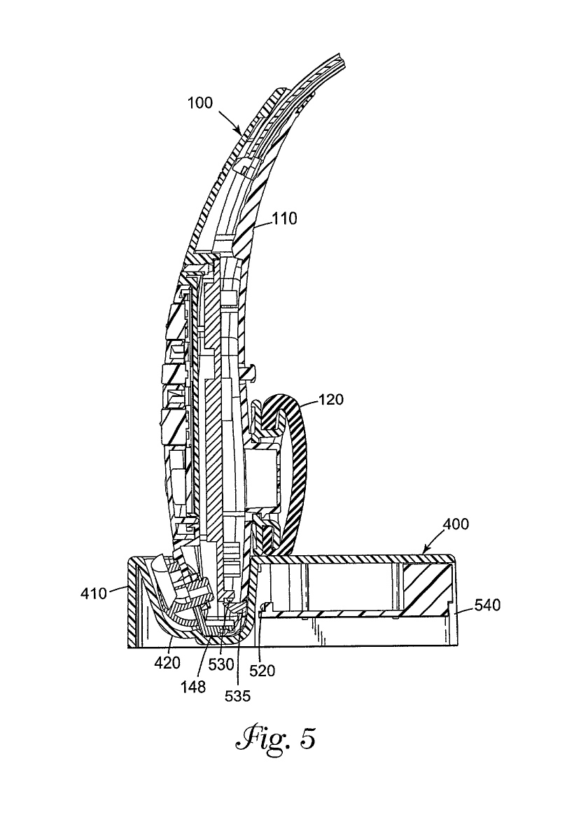

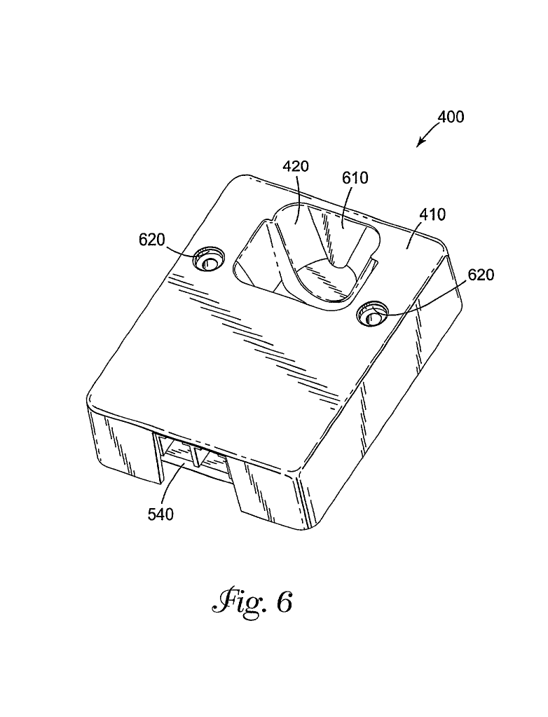

In FIGS. 4-5 the headset assembly 110 is shown with a programming station 400 of one embodiment. The programming station 400 is shown alone in FIG. 6. Now referring to FIGS. 5-6, the programming station or programming unit 400 may include a cradle portion 420 defined in a housing 410 that receives a portion of the electronics housing 110 of the headset assembly 100.

The headset assembly 110 may be positioned in the programming unit 400 in order for an operating program to be downloaded to the headset assembly by infrared (IR) transmission. The operating program may include information for operation of the headset assembly such as operating frequency, lane number and whether the signal is duplex or simplex. When a portion of the headset 100 is placed into the cradle portion of the programming station 400, the microphone boom 135 may be placed in an upward position so that it does not interfere with the placement of the headset assembly, as illustrated in FIG. 4. The cradle portion 420 may include a portion 610 for accommodating the microphone boom, as shown in FIG. 6.

The programming unit may also include an infrared detector for detecting an infrared light signal from the headset assembly. In one embodiment, the headset sends an infrared signal to the programming station when it is ready for receiving a program from the programming station. The programming station and the headset include an IR light detector emitter in this embodiment.

The cradle portion 420 provides a physical reference point for positioning the headset 100 to receive a program from the programming station 400. It is simple for a user to position an end portion or detector portion 148 of the electronics housing 110 of the headset 100 in the cradle portion 420, and thereby bring the infrared light detector emitter 530 of headset into close proximity with the infrared light detector emitter 520 of the programming station 400.

The programming station 400 may include a physical structure different than the cradle portion 420 in order to assist a user with positioning the infrared light detector of the headset near the infrared light transmission element of the programming station. For example, the cradle could be open on one side or both sides, a groove could be included instead of a cradle, or many other physical configurations.

The programming station 400 includes a housing 410 with at least a portion of material that is infrared transparent to allow for communication between an infrared emitter or transmitter of the programming unit and an infrared detector of the headset. In a preferred embodiment, the entire housing of the programming station 400 is made of an infrared transparent material. Preferably, at least the cradle portion consists of only one piece of material without any seams. A one-piece construction for at least the cradle portion reduces the risk that the internal components of the programming unit will be contaminated by liquid, food, grease or any other damaging substances. Most preferably, the entire housing of the programming unit is made of one piece of an infrared transparent material to reduce the risks of damaging substances entering the interior of the housing.

One preferred material for the housing of the programming station is acrylic butyl styrene (ABS) with an infrared concentrate dye added for IR light transparency. The headset may also be made of ABS, preferably with a small window of IR light transparent material, such as ABS with an IR concentrate dye. The programming station may include holes 620 for mounting on a wall or other surface. A cable connection 540 may also be included in programming station 400.

FIG. 5 shows a cross-sectional view of the headset 100 positioned in the cradle portion 420 of the programming unit 400. An infrared light detector emitter element 520 is shown within the programming unit 400. An infrared light detector and emitter element 530 is shown within the detector portion 148 of the headset assembly 100. An IR reflector 535 is positioned to reflect light toward the IR detector emitter 530. When the detector portion 148 of the headset assembly 100 is positioned in the cradle portion 420 of the programming unit 400, then the headset infrared light emitter detector 530 is in close proximity with the programming unit infrared detector and emitter 520. During programming the headset IR light emitter detector and the programming station IR light emitter detector are preferably spaced apart from each other by 10 cm or less, more preferably 5 cm or less, still more preferably 3 cm or less and in a preferred embodiment about 1 cm.

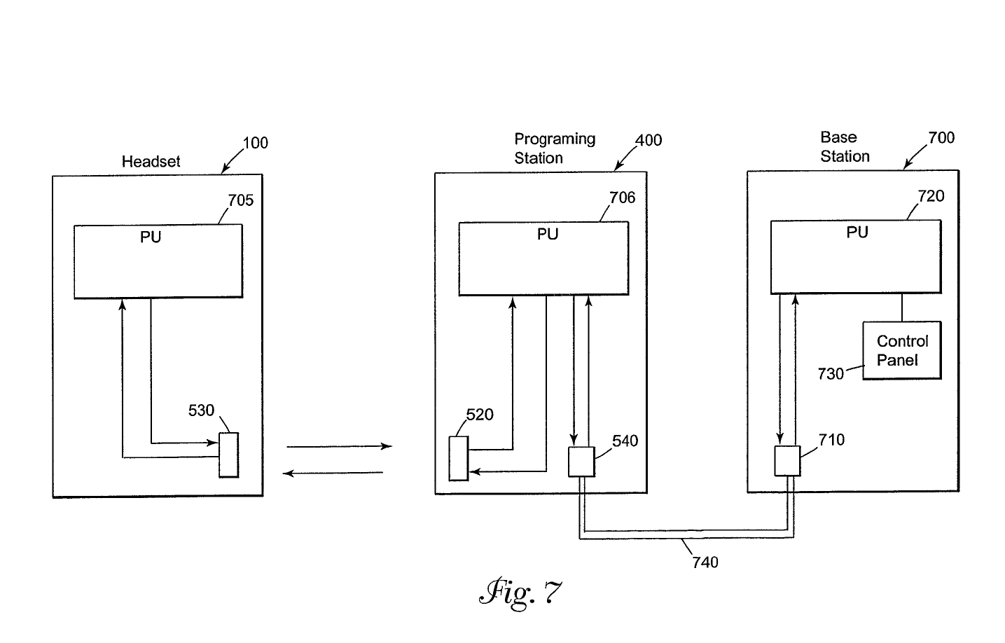

FIG. 7 shows a block diagram of a headset assembly 100, programming station 400 and base station 700 of the present invention. The headset assembly 100 includes an infrared detector emitter 530 connected to a signal processing unit (PU) 705. The programming station 400 includes an infrared light transmission and receiving element 520 and a signal processing unit (PU) 706. The programming unit 400 also includes a cable connection 540. In one embodiment, the programming station may be connected to a base station 700 that includes a cable connection 710, a signal processing unit 720 and a control panel 730 by cable 740.

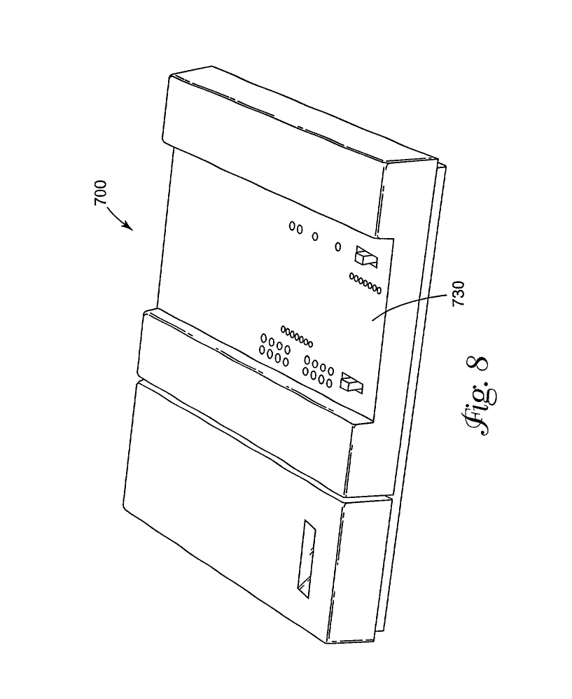

FIG. 8 shows one example of a base unit 700. The base unit 700 includes a control panel 730 where a user may turn the system on and off and select settings. For example, the control panel may allow a user to switch between a day mode and a night mode, enter the desired frequency, lane designations or duplex and simplex designations, and/or input other information or programming settings. The main base unit 700 may also include numerous LED indicators for showing when each headset is in use, the mode of use (for example, talk or page), and/or which channels are in use.

FIG. 7 illustrates some components of the headset, programming station and base station of the present invention. However, FIG. 7 does not show all functional components of the system. For example, the headset may in some embodiments include additional functional components. The headset may include one or more of a speaker, an audio receiver, an audio transmitter, a microphone, a power source, an LED indicator or indicators, and input devices for volume, operation mode, talk lock mode, page mode or other features. The provision of these types of components and other components that are useful with communication systems is generally known by those of skill in the art.

A method of programming the headset assembly will now be described. First, the portion of the headset assembly including an infrared detector and emitter element is brought into close proximity with the programming unit. For example, a detector portion of the headset assembly may be inserted into the cradle portion 420 of the programming unit 400. Before insertion into the cradle portion, the microphone boom of the headset assembly may be moved into an upward position to accommodate placement of the electronics housing into the cradle portion 420 of the programming unit 400.

After the headset is inserted into the cradle portion, or similar structure, of the programming station, an indication is provided to the processing unit of the programming station that it should transmit a program to the headset. One example of such an indication is an infrared signal from the headset assembly to the programming station. For example, the headset may transmit a ready indication when it is turned on. According to this example, the headset should be inserted into the cradle portion and then turned on, causing an infrared signal to be transmitted to the programming station that the headset is ready to receive a program. Many other indicators may be used to communicate a ready indication to the programming station. For example, an infrared signal may be sent to the programming station by the headset upon depression of a button or other switch on the headset. In the alternative, non-infrared indicators could be used. Mechanical switches could be activated by the placement of the headset into the cradle portion. Light beam indicators and other indicators may also be used.

When the programming station receives the ready indicator from the headset, it communicates with the base station. The base station then downloads a program to the programming station. The programming station converts the downloaded data into an infrared light signal and sends it to the headset. The headset receives the infrared light signal and converts the infrared light signal into an electric signal. The electric signal is received by the signal processing device 110 of the headset. The received signal indicates an operation program to the signal processing device 110 of the headset 100.

The configuration described herein includes a headset assembly, a programming station and a base station. In the illustrated embodiment, different functions of the system are divided between the programming station and the base station. For example, the programming station includes the infrared detector and emitter for communication of an infrared signal to the headset. The base station includes a control panel for receiving settings from the user. By dividing functions of the system between the separate physical components of the programming station and base station, advantages are achieved in some situations. This configuration allows a programming station to be positioned in a location that is convenient for the wearers of the headset to download a program without needing to accommodate the larger base station having a control panel in the same location. It may also be desirable for the base station with the control panel to be placed in a location where it will not be accidentally bumped or have the programming selections changed by an unauthorized person. As a result, it may be desirable for the programming station and the base station to be in separate units, as shown in the drawings.

In the illustrated embodiment, the programming station is smaller than the base station. The programming station in a preferred embodiment has dimensions of about 3 inches (8 cm) wide, 3.6 inches (9 cm) tall and 1.1 inches (2.8 cm) deep. In one embodiment, the programming unit it sized so that it could be mounted on a wall easily. The base station preferably has dimensions of about 11 inches (28 cm) wide, 8.5 inches (22 cm) tall, and 1.75 inches (4.4 cm) deep. The base station is preferably large enough to allow a user to easily choose operating parameters. Also, preferably the base station is sized to allow mounting on a wall.

Many other configurations of the present invention are also possible. For example, a programming station may include the functionalities of both downloading the program and inputting the user's choices with a control panel. One unit may include an infrared detector and emitter, a cradle portion near the infrared detector and emitter, a signal processing unit, and a control panel. In addition, other configurations are possible, combining the features of the programming station and the base station into one unit.

The various embodiments described above are provided by way of illustration only and should not be construed to limit the invention. Those skilled in the art will ready recognize various modifications and changes which may be made to the present invention without strictly following the exemplary embodiments and applications illustrated and described herein and without departing from the true spirit and scope of the present invention which is set forth in the following claims.

What is claimed is:

1. A programmable headset comprising:
a headband; and
an electronics housing including:
a headset infrared light detector arranged to receive infrared light signals, convert the infrared light signals into electric signals and supply the electric signals to an output, the headset infrared light detector being located in a detector portion of the electronics housing;
a headset signal processing device with an input coupled to the output of the headset infrared light detector for processing the electric signals supplied by the headset infrared light detector;
a transmitter operably connected to the headset signal processing device; and
a receiver operably connected to the headset signal processing device.

2. The headset of claim 1 further comprising a battery attached to the headband and operably connected to the headset signal processing device.

3. The headset of claim 1 further comprising a programming unit comprising:
a cradle for receiving the detector portion of the headset,
a programming unit signal processing device with an output;
a programming unit infrared light emitter positioned for infrared light communication with the headset infrared light detector when the detector portion is positioned in the cradle, the programming unit infrared light emitter being operably connected to the output of the programming unit signal processing device.

4. The headset of claim 3 further comprising:
a headset infrared light emitter operably connected to an output of the headset signal processing unit; and
wherein the programming unit further comprises a programming unit infrared light detector arranged to receive infrared light signals, convert the received infrared light signals into electric signals and supply the electric signals to an input of the programming unit signal processing device.

5. The headset of claim 1 wherein the detector portion of the electronics housing is located at an end of the electronics housing.

6. The headset of claim 1 wherein the detector portion of the headset includes at least a window of infrared light transparent material.

7. The headset of claim 1 wherein the headband includes a speaker and a microphone, wherein the headband is operably coupled to the electronics housing by a wire connection.

8. The headset of claim 1 wherein the electronics housing is attached to the headband and the electronics housing includes a speaker and a microphone.

9. An apparatus for programming a headset, comprising:
a headset comprising:
a headband,
a headset signal processing device including an input,
a headset infrared light detector positioned in a detector portion of the headset and arranged to receive infrared light signals, convert the infrared light signals into electric signals and supply the electric signals to an output that is coupled to the input of the headset signal processing device, and
a speaker operably connected to the headset signal processing device; and
a programming unit comprising:
a cradle for receiving the detector portion of the headset,
a programming unit infrared light emitter for communication with the headset infrared light detector when the detector portion of the headset is positioned in the cradle, and
a programming unit signal processing device operably connected to the programming unit infrared light emitter.

10. The apparatus of claim 9 further comprising a base unit connected to the programming unit, the base unit comprising a control panel.

11. The apparatus of claim 9 wherein the programming unit further comprises a control panel.

12. The apparatus of claim 9 wherein the programming unit is wall mountable.

13. The apparatus of claim 9 wherein the detector portion of the headset is located at an end of the headset.

14. The apparatus of claim 9 wherein the detector portion of the headset includes at least a window of infrared light transparent material.

15. The apparatus of claim 9 wherein the programming unit further comprises a programming unit housing at least partially enclosing the programming unit infrared light emitter and the programming unit signal processing device, wherein the cradle is defined in the housing and at least a portion of the cradle comprises an infrared light transparent material.

16. The apparatus of claim 15 wherein the cradle consists of an infrared light transparent material.

17. The apparatus of claim 16 wherein the programming unit housing consists of an infrared light transparent material.

18. The apparatus of claim 9 wherein the headset further comprises an electronics housing that includes the headset signal processing device, the headset infrared light detector and the speaker, and wherein the detector portion of the headset is a part of the electronics housing.

19. The apparatus of claim 9 wherein the headset further comprises a headset infrared light emitter and the programming unit further comprises a programming unit infrared light detector.

20. A method of programming a headset comprising:
positioning a detector portion of a headset in a cradle of a programming station, where the headset comprises a headset infrared light detector for receiving signals from a programming station infrared light emitter;
transmitting an infrared light signal from the programming station infrared light emitter to the headset infrared detector, where the signal contains information regarding operation settings of the headset;
establishing operation settings of the headset in response to the signal.

21. The method of claim 20 further comprising:
indicating a ready condition for receiving a programming signal of the headset by transmitting an infrared light signal from a headset IR detector emitter to a programming station IR detector emitter, after.

22. The method of claim 22 wherein the step of indicating a ready condition further comprises turning the headset on.
